(19) United States
(12) Patent Application Publication
(10) Pub. No.: US 2003/0066403 A1
(43) Pub. Date: Apr. 10, 2003

(54) Multi-module Venetian blind cutting machine

(75) Inventors: Jung-Kuei Lin, Hsinchu (TW); Ya-Wei Hsu, Hsinchu (TW); Kuei-Lu Liu, Hsinchu Hsien (TW)

Correspondence Address: BROWDY AND NEIMARK, P.L.L.C., 624 NINTH STREET, NW, SUITE 300, WASHINGTON, DC, 20001-5303, US

(73) Assignee: INDUSTRIAL TECHNOLOGY RESEARCH INSTITUTE, Hsinchu Hsien (TW)

(21) Appl. No.: 09/955,150

(22) Filed: Sep. 19, 2001

(51) Int. Cl. B23D 23/00

(52) U.S. Cl. 83/412; 83/454; 83/467.1; 83/485

(57) ABSTRACT

A multi-module Venetian blind cutting machine is disclosed to include a machine base, and a cutting-off unit and a saw unit respectively mounted in the machine base, the cutting-off unit including a carriage having multiple workpiece positioning tools, the carriage being moved to shift the selected workpiece positioning tool to a working position to hold the Venetian blind to be cut for cutting, and a cutting-off tool driving mechanism adapted to move a cutting-off tool to cut the loaded Venetian blind, the saw unit having a circular saw, and a saw drive adapted to move and rotate the circular saw to cut the loaded Venetian blind.

### BACKGROUND OF THE INVENTION

The present invention relates to a cutting machine and, more specifically, to a multi-module Venetian blind cutting machine.

Venetian blind manufacturers commonly provide certain sizes (lengths of the top and bottom rails and the slats) for each model. Distributors or upholsters select the desired sizes and then cut off the excessive part to fit different windows.

According to early methods, top rails, bottom rails, and slats are separately cut. This method wastes much time, and is difficult to keep the ends of the cut parts in flush. Nowadays, various Venetian blind cutting machines have been developed for cutting top rails, bottom rails and slats at a time. Regular Venetian blind cutting machines include two types, one using a circular saw to cut the workpieces, the other using a cutting-off tool to cut off the workpieces. Circular saw type Venetian blind cutting machines achieve flush cutting edges and high cutting speed, however they produce much powdered dust during cutting. Further, these cutting machines cannot achieve a curved cutting edge. Cutting-off tool type Venetian blind cutting machine are seen in U.S. Pat. Nos. 5,799,557; 5,927,172; 6,089,302, and etc. These cutting machines commonly use a workpiece positioning tool with positioning holes to hold the rails and slats in position for cutting, and a hydraulic cylinder or motor to move a cutting-off tool to cut the workpieces. These cutting machines produce less amount of powdered dust, and can out arched or chamfered edges by means of the application of different cutting-off tools. However, the working efficiency of these cutting machines is low, and the cut parts may have uneven edges. In general, the aforesaid two different types of Venetian blind cutting machines have respective advantages and drawbacks, and are selected subject to different requirements.

Further, Venetian blind cutting machines of the prior art have another drawback. In order to process Venetian blinds of different specifications, regular Venetian blind cutting machines allow the user to change the workpiece positioning tool and the cutting-off tool to fit workpieces of different specifications. However, it is inconvenient to change the workpiece positioning tool and the cutting-off tool when cutting a different size of Venetian blind.

### SUMMARY OF THE INVENTION

The present invention has been accomplished under the circumstances in view. It is therefore the main object of the present invention to provide a multi-module Venetian blind cutting machine, which provides a cutting-off tool cutting mode and a circular saw cutting mode for choice.

It is another object of the present invention to provide a multi-module Venetian blind cutting machine, which enables the user to change the workpiece positioning tool and the cutting-off tool conveniently subject to the type of the Venetian blind to be cut.

To achieve these objects of the present invention, the multi-module Venetian blind cutting machine comprises a machine base, a cutting-off unit and a saw unit mounted on the base respectively. The cutting-off unit comprising a carriage, at least two workpiece positioning tools mounted on said carriage with each enabling to fasten the Venetian blind to be cut, a positioning tool change-control driving mechanism adapted to drive the carriage to move such that one of the positioning tools can be moved to a working position for receiving and fastening the Venetian blind, and a cutting-off tool driving mechanism adapted to drive a cutting-off tool forward the Venetian blind at the working position so as to cut off said Venetian blind. The saw unit comprising a circular saw, and a saw drive adapted to rotate the circular saw and to move the circular saw along a path to cut off the Venetian blind. The circular saw having the axis extended in direction parallel to the longitudinal axis of the inserted Venetian blind to be cut, and a saw drive adapted to rotate the circular saw and to move the circular saw along a path substantially perpendicular to the longitudinal axis of the inserted Venetian blind to be cut so as to cut the inserted Venetian blind.

### BRIEF DESCRIPTION OF THE DRAWINGS

FIG. 1 is a front plain view of a multi-module Venetian blind cutting machine according to the present invention.

FIG. 2 is a top plain view of the multi-module Venetian blind cutting machine according to the present invention.

FIG. 3 is a sectional view taken along line 3-3 of FIG. 2.

FIG. 4 is an exploded view of a part of the present invention, showing the structure of the workpiece positioning tool, the carriage, and the cutting-off tool.

FIG. 5 is a front plain view of a part of the present invention, showing the workpiece positioning tool and the cutting-off tool positioned in the carriage.

FIG. 6 is a right side view of a part of the present invention, showing the cutting-off tool moved to the initial position in the corresponding holder frame at the carriage.

FIG. 7 is similar to FIG. 6 but showing the cutting-off tool moved to the cutting off position.

FIG. 8 is a top plain view of a part of the present invention showing the cutting-off tool coupled between the cutting-off tool driving mechanism and the corresponding workpiece positioning tool.

### DETAILED DESCRIPTION OF THE PREFERRED EMBODIMENT

Referring to FIGS. from 1 through 3, a multi-module Venetian blind cutting machine in accordance with the present invention is generally comprised of a machine base 10, a cutting-off unit 20, and a saw unit 90.

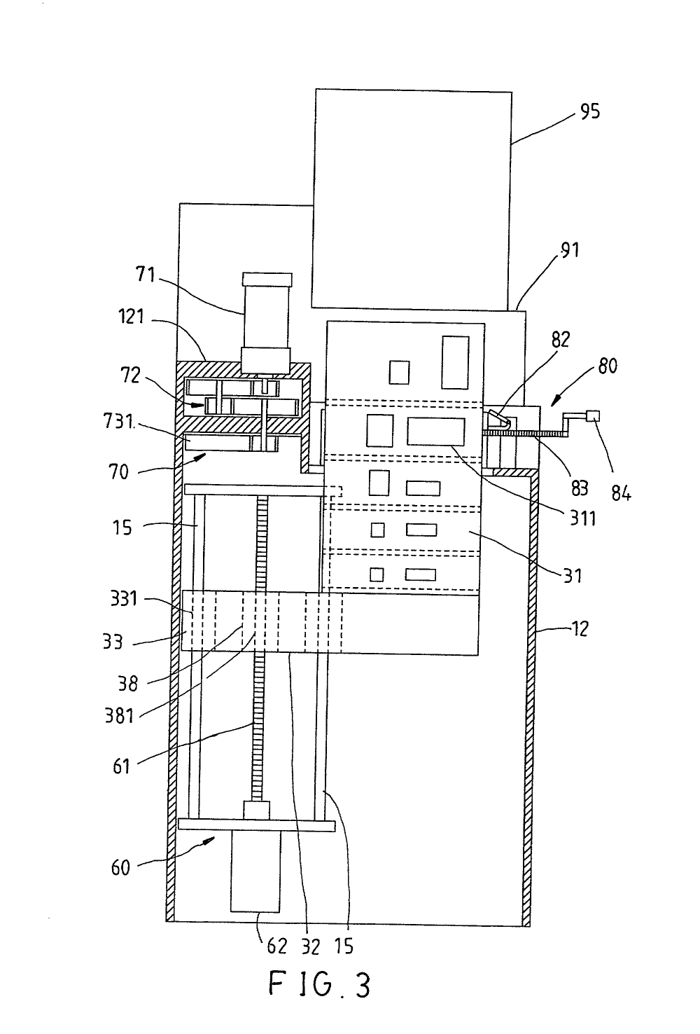

The machine base 10 is stably supported on the floor, comprising a stand 11 and a casing 12 fixedly provided at the left side of the stand 11. The top side of the stand 11 and the top side of the casing 12 form a work table 13. A rack 121 is provided in the rear part of the top side of the casing 12. An opening 122 is provided in the front part of the top side of the casing 12. A pulley support 14 is fixedly provided at the front side of the opening 122 to support two pulleys 141 at different elevations. Two vertical guide rods 15 are provided inside the casing 12 (see FIG. 3).

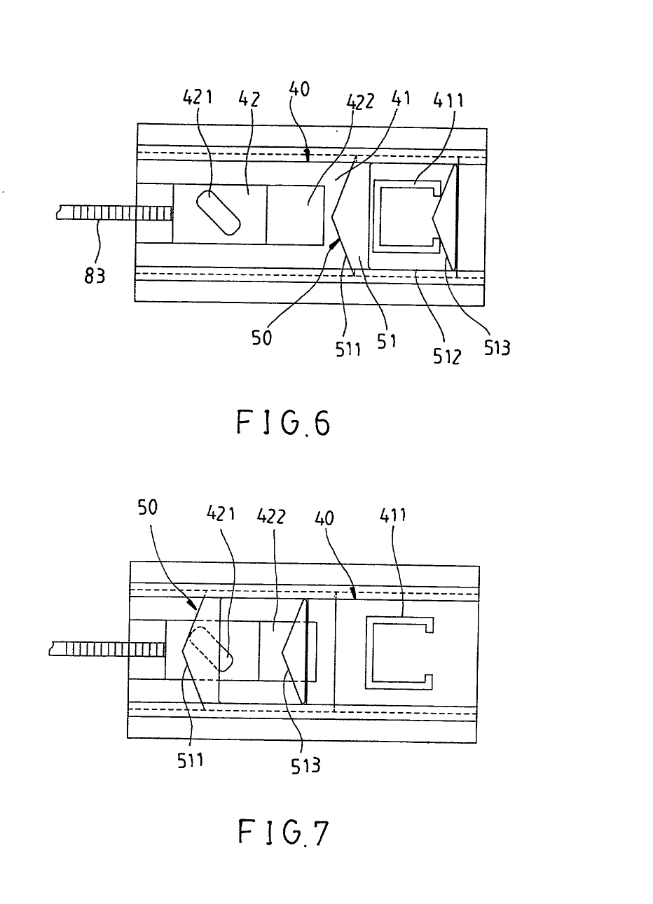

The cutting-off unit 20 is provided inside the machine base 10 at the left side (i.e., within the casing 12) and adapted to hold and cut the workpieces, comprising a carriage 30, a set of workpiece positioning tools 40, a set of cutting-off tools 50, a positioning tool change-control driving mechanism 60, a cutting-off tool driving mechanism 70, and a holding down mechanism 80. The carriage 30 is vertically movably mounted in the machine base 10, comprising a base plate 31 disposed in the opening 122 of the casing 12, the base plate 31 having a plurality of through holes 311, a rear extension board 32 extended from the rear side of the base plate 31, two coupling blocks 33 provided at the inner side of the rear extension board 32 remote from the base plate 31, the coupling blocks 33 each have a vertically extended pivot hole 331 respectively coupled to the guide rods 15, a vertical rod 34 supported on the pulleys 141 in the casing 12 to guide vertical movement of the carriage 30, a plurality of horizontal partition plates 35 fixedly fastened to the base plate 31 at an inner side (the right side) and defining a plurality of, for example, five vertically spaced mounting spaces 36, and a plurality of [symbol] -shaped holder frames 37 respectively fixedly mounted in the mounting spaces 36, each holder frame 37 having two stop flanges 371 respectively inwardly extended from top and bottom sidewalls thereof and two openings 372 respectively aimed at a respective through hole 311 of the base plate 31 (see FIG. 6). Because the holder frames 37 are provided for the positioning of workpiece positioning tools and cutting-off tools of different specifications and the through holes 311 and openings 372 are provided for the insertion of Venetian blinds of different sizes from the left side toward the right side, the mounting spaces 36 have different vertical heights, the holder frames 37 have different transverse lengths, and the through holes 311 and openings 372 have different sizes and positions. Alternatively, the base plate 31 can be made having only one through hole in each mounting space 36, and each holder frame 37 can be made having only one opening (having an extended width). When moving the carriage 30 to the upper limit position, the lowest mounting space 36 is about at the elevation of the work table 13 of the machine base 10. When moving the carriage 30 to the lower limit position, the top edge of the base plate 31 is disposed below the elevation of the work table 13.

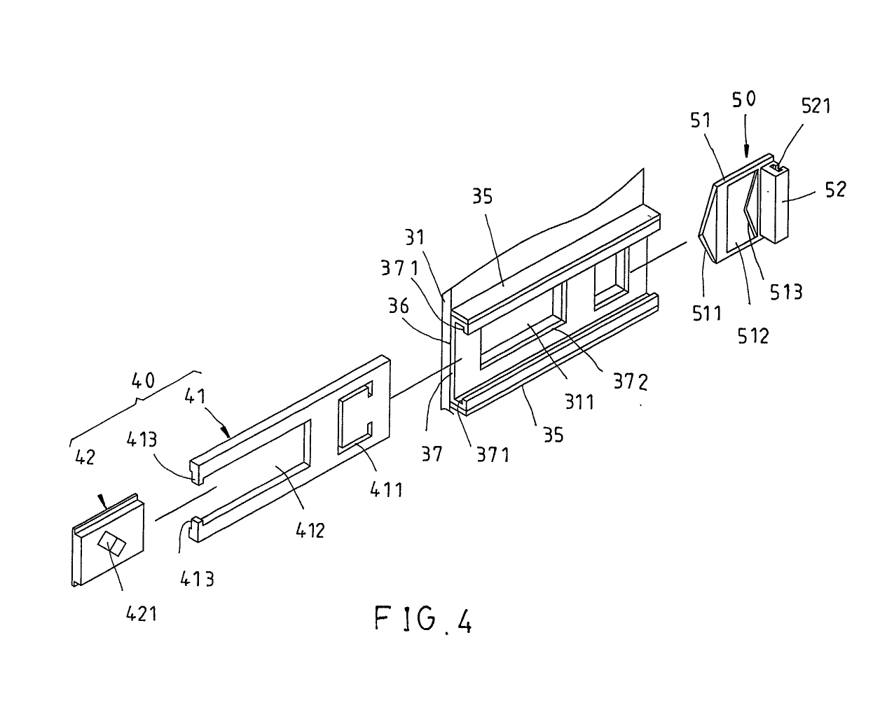

According to the present preferred embodiment, the number of the workpiece positioning tools 40 is 5. The workpiece positioning tools 40 are respectively mounted in the holder frames 37, each comprising a base member 41, and a slide 42. The base member 41 is a flat rectangular member fitting the length of the holder frames 37 comprising a top rail insertion hole 411, corresponding to the openings 372 of one holder frame 37, a sliding slot 412 extending backward from the front end of the base member 41, and two stop flanges 413 bilaterally inwardly disposed at the open end of the sliding slot 412 and adapted to stop the slide 42 in the sliding slot 412. The sliding slot 412 has a T-shaped cross section with the wider section disposed at the inner (left) side and the narrower section disposed at the outer (right) side. The slide 42 is adapted to move in the sliding slot 412, having a cross section fitting the sliding slot 412. Further, the slide 42 has a bottom rail insertion hole 421. After installation of the slide 42 in the sliding slot 412 of the base member 41, a slat insertion hole 422 is defined within the base member 41 between the rear side of the slide 42 and the inner end of the sliding slot 412. When moving the slide 42 in the sliding slot 412, the horizontal width of the slat insertion hole 422 is relatively changed. As indicated above, the workpiece positioning tools 40 are adapted to hold Venetian blinds of different specifications. FIG. 4 show only one workpiece positioning tool 40 of a particular specification. The other workpiece positioning tools 40 have the same structure with the exception of the different size and location of the top rail insertion holes 411, bottom rail insertion holes 421 and slat insertion holes 422.

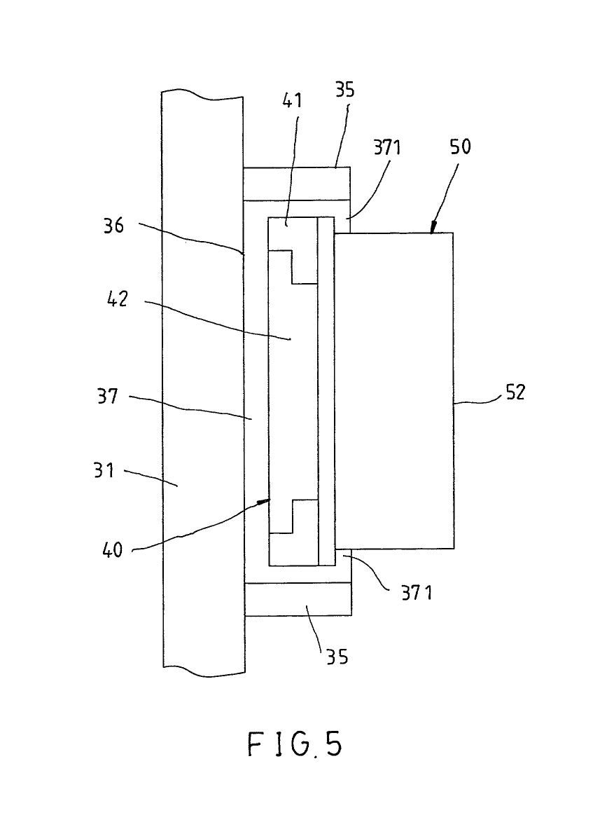

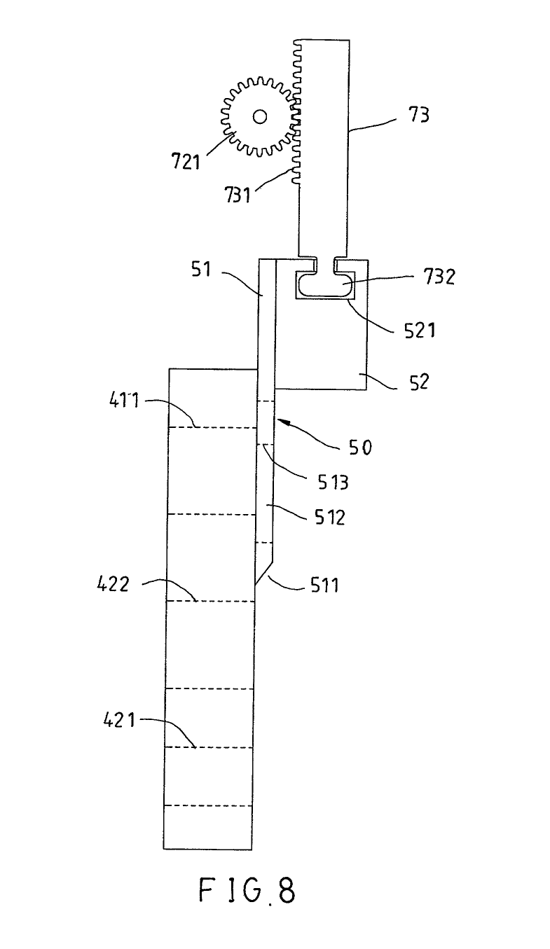

The cutting-off tools 50 (according to the present preferred embodiment, the number of the cutting-off tools 50 is 5) are respectively mounted in the holder frames 37 of the carriage 30. As shown in FIG. 4, each cutting-off tool 50 comprises a cutter blade 51, and a coupling block 52 fixedly fastened to the rear end of the cutter blade 51 at an inner side. The cutter blade 51 has a center opening 512, a first triangular cutting edge 511 at one side, namely, the front side of the center opening 512, and a second triangular cutting edge 613 at the other side, namely, the rear side of the center opening 512. The top and bottom sides of the coupling block 52 are respectively spaced from the top and bottom edges of the cutter blade 51 at a distance. The coupling block 52 has a rear coupling groove 521. According to the present preferred embodiment, the coupling groove 521 is a T-shaped groove. As illustrated in FIG. 5, the cutting-off tool 50 is inserted into one holder frame 37. After installation, the inner side of the cutting-off tool 50 is disposed in contact with the outer side of the workpiece positioning tool 40 in the holder frame 37, the outer side of the cutting-off tool 50 is supported on the stop flanges 371 of the holder frame 37 and the coupling block 52 is disposed outside the holder frame 37. Therefore, the cutting-off tool 50 can be moved back and forth in the corresponding holder frame 37. When moving the cutting-off tool 50 to the initial position at the rear side (the right side) as shown in FIG. 6, the center opening 512 is aimed at the top rail insertion hole 411 wherein the second triangular cutting edge 513 is disposed at the rear side (right side) of the top rail insertion hole 411 and the first triangular cutting edge 511 is disposed between the slat insertion hole 422 and the top rail insertion hole 411. When moving the cutting-off tool 50 from the initial position to the front cutting-off position as shown in FIG. 7, the first triangular cutting edge 511 moved over the slat insertion hole 422 and the bottom rail insertion hole 421, and the second triangular cutting edge 513 moved over the top rail insertion hole 411. Because the cutting-off tools 50 match the workpiece positioning tools 40, they have different sizes and shapes. All the cutting-off tools 50 are set in the respective initial position, keeping the respective coupling holes 521 vertically aligned in a line.

The positioning tool change-control driving mechanism 60 is adapted to move the carriage 30 up and down, enabling one particular workpiece positioning tool 40 and the matching cutting-off tool 50 to be shifted to the elevation of the work table 13 of the machine base 10, i.e. the working position where the top rail insertion hole 411, the slat insertion hole 422, and the bottom rail insertion hole 421 are disposed at the elevation slightly higher than the work table 13. As shown in FIG. 3, a screw rod 61 is pivotally vertically mounted in the casing 12 between the guide rods 15, and a motor 62 is mounted inside the casing 12 and adapted to rotate the screw rod 61. A locating block 38 is fixedly fastened to the extension board 32. The locating block 38 has a screw hole 381 extended through top and bottom sides thereof. The screw rod 61 is threaded through the screw hole 381 of the locating block 38. When starting the motor 62 to rotate the screw rod 61 clockwise or counter-clockwise the carriage 30 is forced to move upwards or downwards. A respective limit switch (not shown) is respectively mounted on the front side of the base plate 31 adjacent to each mounting space 36. A protruding device (not shown) is provided in the casing 12 adjacent to the work table 13. When the carriage 30 moved to the desired elevation, the protruding device in the casing 12 triggers the corresponding limit switch to turn off the motor 62, and therefore the carriage 30 is set in the desired elevation. A step motor or any suitable known measure may be used to control the positioning of the carriage 30.

The cutting-off tool driving mechanism 70 is adapted to move the working cutting-off tool 50 (the cutting-off tool being moved to the working position) forwards or backwards. According to the present preferred embodiment, the cutting-off tool driving mechanism 70 comprises a motor 71 mounted in the upright rack 121 of the machine base 10 in a downwardly extended position, a transmission gear set 72 mounted in the upright rack 121 and coupled to the output shaft of the motor 71 (preferably the transmission gear set 72 uses small gears to rotate big gears), a movable plate 73 coupled to the transmission gear set 72. The movable plate 73 comprises an integrated rack 731 vertically fixedly disposed at the left side thereof and meshed with the output gear 721 of the transmission gear set 72, and a T-shaped coupling block 732 extended from the front side thereof. When moving the movable plate 73 to the rear initial position, the T-shaped coupling block 521 is set into vertical alignment with the rear coupling groove 521 of the coupling block 52 of each cutting-off tool 50 so as not to hinder vertical movement of the carriage 30. When moving the carriage 30 to the desired position to hold the assigned cutting-off tool 50 in the working position, the T-shaped coupling block 732 is coupled to the T-shaped coupling block 521 of the working cutting-off tool 50 (see FIG. 8), at this time the operator can control the motor 71 to move the movable plate 73 forwards, so as to force the working cutting-off tool 50 forwards. After reaching the cutting-off position, the working cutting-off tool 50 is returned to the initial position. Similar to the control of the positioning tool change-control driving mechanism 60, limit switch means may be installed to detect the presence of the working cutting-off tool 50 (or the movable plate 73) in the cutting-off position. Alternatively, a step motor may be used to control the return of the working cutting-off tool 50 automatically after the working cutting-off tool 50 reached the cutting-off position.

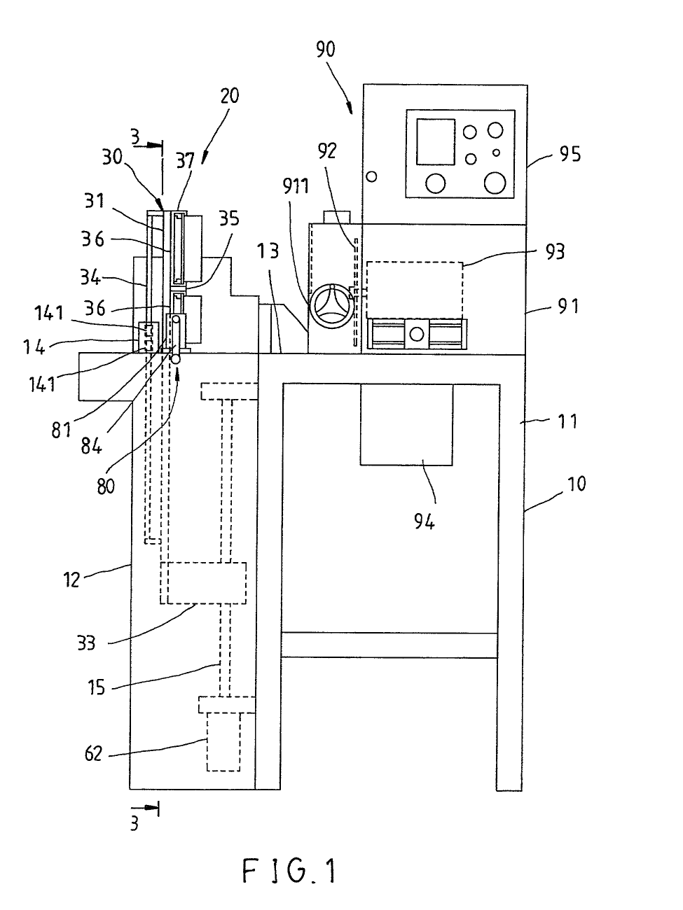

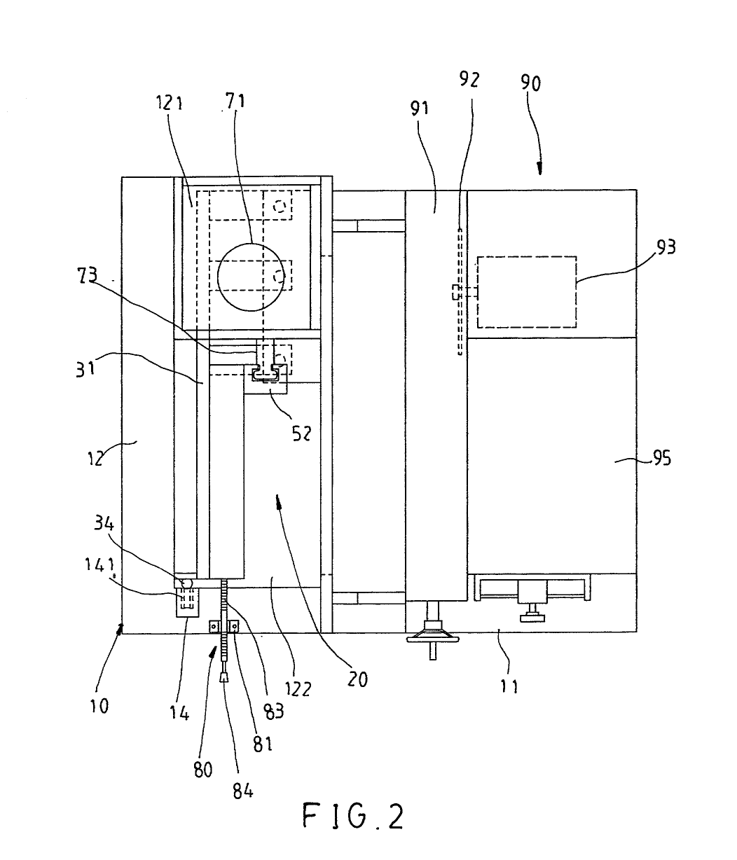

The holding down mechanism 80 is a prior art, as shown in FIGS. 1-3, comprises a base mounting frame 81 fixedly mounted on the machine base 10 in the front side of the opening 122 of the casing 12 adjacent to the right side of the pulley support 14, a holding down screw 83 extended through a through hole (not shown) of the base mounting frame 81 corresponding to the elevation of the workpiece positioning tool 40 in the working position, a hand wheel 84 fixedly provided at one end, namely, the front end of the holding down screw 83, and a threaded member 82 pivoted to the base mounting frame 81 and set between the working position where the threaded member 82 is meshed with the holding down screw 83 for enabling the holding down screw 83 to be rotated forwards/backwards by means of turning the hand wheel 84, and the non-working position where the threaded member 82 is disengaged from the holding down screw 83 for enabling the operator to move the holding down screw 83 forwards/backwards with the hand directly without through the hand wheel 84.

The saw unit 90 is installed in the work table 11 of the machine base 10. Unlike the cutting-off unit 20, the saw unit 90 is adapted to cut Venetian blinds by a rotary sawing action. The saw unit 90 is a conventional design comprising a mechanical box 91, and an electric box 95. The mechanical box 91 comprises a circular saw 92, and a saw drive 93. The circular saw 92 is suspended above the work table 13 with its axis extended in left-right direction, and can be moved forwards/backwards. The saw drive 93 is adapted to move the circular saw 92 horizontally forwards/backwards and to simultaneously rotate the circular saw 92 at a high speed when moving it horizontally forwards/backwards. The mechanical box 91 has an insertion hole 911 in the left sidewall thereof through which the Venetian blind is inserted into the mechanical box 91 for cutting. A collector 94 is provided in the machine base 10 below the work table 13, and adapted to guide and gather Venetian blind cut parts. The electric box 95 holds electric distribution wires and control circuit boards on the inside, switches, control buttons, display means, and the like on the outside for controlling the operation of the saw unit 90 and the cutting-off unit 20 (including the positioning tool change-control driving mechanism 60 and the cutting-off tool driving mechanism 70).

The operation of the present invention is outlined hereinafter. Initially, the workpiece positioning tools 40 and the cutting-off tools 50 are respective installed in the carriage 30, and then determine the cutting method (the cutting-off cutting or saw cutting) subject to the type of the workpieces to be cut or the requirements of work. If the cutting-off cutting method is selected, control the positioning tool change-control driving mechanism 60 to move the carriage 30 to the desired elevation, keeping the selected workpiece positioning tool 40 (and the corresponding cutting-off tool 50) set in the working position. Thereafter, the top rail, the slats and the bottom rail are respectively inserted from the left side toward the right side through the through holes 311 of the base plate 31 and the openings 372 of the corresponding holder frame 37 into the top rail insertion hole 411, bottom rail insertion hole 421 and slat insertion hole 422 of the corresponding workpiece positioning tool 40, enabling the top rail to be extended through the center opening 512 of the cutter blade 51 of the corresponding cutting-off tool 50. Because the top rail insertion hole 411 and the bottom rail insertion hole 421 respectively fit the cross section of the top rail and the cross section of the bottom rail, the top rail and the bottom rail are positioned in position after inserted into the top rail insertion hole 411 and the bottom rail insertion hole 421. After insertion of the slats into the slat insertion hole 422, the holding down screw 83 of the holding down mechanism 80 is rotated to move the slide 42 of the corresponding workpiece positioning tool 40 against the inserted slats, so as to hold down the inserted slats in the cutting position. Thereafter, the cutting-off tool driving mechanism 70 is controlled to move the working cutting-off tool 50 from the initial position to the cutting off position (See FIGS. 7 and 8), thereby causing the first triangular cutting edge 511 to cut off the slats and the bottom rail and the second triangular cutting edge 513 to cut off the top rail. The waste cut off parts fall from the opening 122 of the casing 12 to another collector (not shown). IF the saw cutting method is selected, the carriage 30 is moved to the lower limit position to let the base plate 31 be received inside the machine base 10 below the work table 13, and the Venetian blind is directly inserted into the mechanical box 91 of the saw unit 90 over the cutting track of the circular saw 92 for cutting. After the Venetian blind has been set into the cutting position, the saw drive 93 is controlled to feed and rotate the circular saw 92, causing it to cut the top rail, bottom rail and slats of the inserted Venetian blind at the desired length. The waste cut off parts of the Venetian blind are gathered in the collector 94.

As indicated above, the present invention achieves the following advantages.

1. Because the multi-module Venetian blind cutting machine provides a cutting-off tool cutting mode and a circular saw cutting mode for selection, it saves much installation cost and space.

2. The operator can quickly change the workpiece positioning tool and the cutting-off tool subject to the type of the Venetian blind to be cut by means of an electric control without detaching any part of the multi-module Venetian blind cutting machine.

While only one embodiment of the present invention has been shown and described, it will be understood that various modifications and changes could be made thereunto without departing from the spirit and scope of the invention disclosed.

What the invention claimed is:

1. A multi-module Venetian blind cutting machine comprising:
a machine base;
a cutting-off unit mounted in said machine base, said cutting-off unit comprising a carriage movably coupled to said machine base, at least two workpiece positioning tools respectively mounted on said carriage, said workpiece positioning tools each having a set of insertion holes for the positioning of the top rail, slats and bottom rail of a Venetian blind to keep the top rail, slats and bottom rail of the inserted Venetian blind aligned, a positioning tool change-control driving mechanism adapted to move said carriage to further shift one of said workpiece positioning tools to a working position for cutting, at least one cutting-off tool adapted to be moved in the direction in which the top rail, slats and bottom rail of the inserted Venetian blind are aligned, a cutting-off tool driving mechanism adapted to move said at least one cutting-off tool to cut off the top rail, slats and bottom rail of the inserted Venetian blind; and
a saw unit mounted on said machine base, said saw unit comprising a circular saw, said circular saw having the axis extended in direction parallel to the longitudinal axis of the inserted Venetian blind to be cut, and a saw drive adapted to rotate said circular saw and to move said circular saw along a path substantially perpendicular to the longitudinal axis of the inserted Venetian blind to be cut so as to cut the inserted Venetian blind.

2. The multi-module Venetian blind cutting machine as claimed in claim 1 wherein said carriage is coupled to said machine base and moved vertically; said workpiece positioning tools are arranged vertically; the top rail, slats and bottom rail of the Venetian blind to be held in a horizontally aligned position by said workpiece positioning tools.

3. The multi-module Venetian blind cutting machine as claimed in claim 2 wherein said carriage comprises a base plate disposed in vertical, said base plate having a plurality of through holes, a plurality of [symbol] -shaped holder frames respectively fixedly mounted on one side of said base plate at different elevations, said holder frames each having two stop flanges respectively inwardly extended from top and bottom sidewalls thereof and two openings aimed at one through hole of said base plate; said workpiece positioning tools are respectively mounted in said [symbol] -shaped holder frames and respectively spaced from the stop flanges of said [symbol] -shaped holder frames at a distance, having the respective insertion holes respectively aimed at the openings of said holder frames; said cutting-off tools are respectively mounted in said [symbol] -shaped holder frames corresponding to said workpiece positioning tools at an outer side, said cutting-off tools each comprising a cutter blade, and a coupling block fixedly fastened to said cutter blade at an inner side, said cutter blade being mounted in one of said [symbol] -shaped holder frames and supported between the workpiece positioning tool in the corresponding [symbol] -shaped holder frame and the stop flanges of the corresponding [symbol] -shaped holder frame for horizontal movement in the corresponding [symbol] -shaped holder frame, said coupling block having a longitudinally extended coupling hole, the coupling holes of the coupling blocks of said cutting-off tools being vertically aligned in a line; said cutting-off tool driving mechanism comprises a movable plate adapted to be moved in direction parallel to the moving direction of said cutting-off tools, said movable plate comprising a coupling block adapted to engage the coupling hole of one of said cutting-off tools in said working position.

4. The multi-module Venetian blind cutting machine as claimed in claim 1 wherein the insertion holes of each of said workpiece positioning tools include a top rail insertion hole, a slat insertion hole, and a bottom rail insertion hole adapted to receive the top rail, slats and bottom rail of the Venetian blind to be cut.

5. The multi-module Venetian blind cutting machine as claimed in claim 4 wherein said workpiece positioning tools each comprise a base member and a slide, said base member having the aforesaid top rail insertion hole and a sliding slot, said slide being moved in said sliding slot of said base member and having said bottom rail insertion hole, said slide having an inner end defining with a closed end of said sliding slot said slat insertion hole.

6. The multi-module Venetian blind cutting machine as claimed in claim 5 wherein said cutting-off unit further comprises a holding down mechanism, said holding down mechanism comprising a holding down screw adapted to be rotated and moved axially forwards and backwards, having one end adapted to stop against an outer end of the slide of one of said workpiece positioning tools.

7. The multi-module Venetian blind cutting machine as claimed in claim 4 wherein said cutting blade of each of said cutting-off tools comprises a center opening for the passing of the top rail of the Venetian blind to be cut, a first triangular cutting edge disposed at a front side of said center opening and adapted to cut off the slats and bottom rail of the Venetian blind to be cut, and a second triangular cutting edge disposed at a rear side of said center opening and adapted to cut off the top rail of the Venetian blind to be cut.

8. The multi-module Venetian blind cutting machine as claimed in claim 2 wherein said machine base comprises two longitudinal guide rods adapted to guide movement of said carriage, and said carriage comprises two coupling blocks respectively coupled to said guide rods to guide movement of said carriage along said guide rods.

9. The multi-module Venetian blind cutting machine as claimed in claim 2 wherein said positioning tool change-control driving mechanism comprises a locating block fixedly mounted on said carriage, said locating block having a vertically extended screw hole, a crew rod pivotally vertically mounted in said machine base and threaded into the screw hole of said locating block, and a motor controlled to rotate said screw rod in the screw hole of said locating block to force said carriage to move in direction parallel to said screw rod.

10. The multi-module Venetian blind cutting machine as claimed in claim 2 wherein said machine base comprises at least one wheel disposed in a horizontal position perpendicular to the moving direction of said cutting-off tools; said carriage comprises a vertical rod supported on the periphery of each of said at least one wheel.

11. The multi-module Venetian blind cutting machine as claimed in claim 1 wherein said carriage is adapted to be moved rotatably.

12. The multi-module Venetian blind cutting machine as claimed in claim 1 wherein said carriage is adapted to be moved in horizontal direction.
